(19) United States
(12) Patent Application Publication
(10) Pub. No.: US 2016/0286760 A1
(43) Pub. Date: Oct. 6, 2016

(54) INTELLIGENT HANDS-FREE CONTROL DEVICE FOR ANIMAL TRAINING

(71) Applicant: Bernard Manguette, Stembert (BE)

(72) Inventor: Bernard Manguette, Stembert (BE)

(21) Appl. No.: 15/091,514

(22) Filed: Apr. 5, 2016

Related U.S. Application Data
(63) Continuation-in-part of application No. 12/470,388, filed on May 21, 2009, now abandoned.
(60) Provisional application No. 61/055,876, filed on May 23, 2008.

(30) Foreign Application Priority Data
May 23, 2008 (EP) 08447027.7

(51) Int. Cl. A01K 15/02; G08C 17/02; H05C 1/00; A01K 27/00

(52) U.S. Cl. CPC A01K 15/021; A01K 27/001; A01K 15/027; A01K 27/009; G08C 17/02; H05C 1/00

(57) ABSTRACT

An intelligent hands-free electronic control kit for animal training, comprising a hands-free electronic control device in the form of a finger-wearable part, having at least one switch under the form of a push-button and a means of wireless bidirectional telecommunication with a remote control; a wireless remote control having a means of wireless bidirectional telecommunication on the one hand with the hands-free electronic control device in the form of a finger-wearable part, and on the other with a functional electronic receiver accessory, so that the remote control is able to relay an order triggered by the switch of the hands-free electronic control device towards the electronic receiver accessory; and a functional electronic receiver accessory, having a means of wireless bidirectional telecommunication with the remote control; wherein the switch is provided with means allowing to select and trigger distinct functions of the accessory according to as how the push-button is pressed by an user and optionally according to spatial position/orientation of the hands-free electronic control device.

### CROSS REFERENCE TO RELATED APPLICATIONS

The present application is a continuation-in-part of U.S. patent application Ser. No. 12/470,388, filed May 21, 2009, which claims priority to and benefit of U.S. Provisional Application No. 61/055,876, filed May 23, 2008, and European Patent Application No. EP08447027.7, filed May 23, 2008, all of which are hereby incorporated by reference, in their entireties.

### BACKGROUND

1. Technical Field

The field relates to a device of the type hands-free kit for allowing intelligent activation and operation of a wireless radio-frequency remote control.

The application field is the one of remotely controlled electronic devices, and in particular the one of animal training by radio-electronic means.

2. Description of Related Technology

In the context of animal training, a series of radio-frequency control systems intended for training or confining are known that use on the one hand a wireless remote control and on the other hand a receiver for example embedded in a necklace worn by the animal, in particular by a dog. The general purpose of these systems is to remotely transmit stimuli aimed at inducing specific behavior in the animal such as electrical, audio, olfactory, etc. stimulation. See for example: U.S. Pat. No. 6,019,066, JP-A-2000/262174, US-A-2007/191913, U.S. Pat. No. 6,549,133 B2, US-A-2007/204803, U.S. Pat. No. 5,815,077, etc.

In modern training systems for animals, and specifically in dog training, the trainer needs using remote controlled systems having a radio waves range going from 10 m up to a few hundred meters.

Such a kind of system is used to remotely control an assortment of accessories, not limited to electronic training collars, such as bird and ball launchers, food feeders, etc.

In this background, it is often useful for the hunter or the trainer to be able to control his dog while at the same time carrying out one or more other actions that may require the use of both hands.

Moreover, holding a remote control in one's hand for some time, for example whilst walking, may prove uncomfortable in the long run, even if today's remote controls are rather small and light.

As the main issue of using remote controls remains their dimensions, holding a remote control in hand however often prevents carrying out real training tasks such as:

thanking the dog after a suitable behavior,

launching an object,

giving food as a reward to the dog, etc.

This could be a high handicap for the trainer.

Another issue is that the dog, while seeing the remote control, may only correctly react to the trainer's order if the latter actually has the remote control in his hand.

US 2009/0199786 A1 discloses a remote control system for controlling a remote animal collar of the type which includes one or more electrodes or sensors which protrude from the inside surface of the collar for contacting the neck of the animal and electronic devices located within the body of the collar to receive electronic control signals or sensor input and to generate a stimulus, which is transmitted to the animal through the electrodes or by a speaker or other devices on the collar. The remote control system uses a slave transmitter for transmitting slave control signals and a master transmitter for the user's hold on the portable device.

US 2015/0156990 A1 discloses an animal training system for controlling the behavior of the animal including a receiver configured to be worn by the animal, and a hand held transmitter. The hand held transmitter includes a case with a front face, a transmitter circuit within the case for transmitting a wireless signal to the receiver, and an actuator at the front face of the case. The actuator is coupled with the transmitter circuit, and is a non-depressible actuator which is manually movable relative to the case. The actuator, being of the form of a knob, dial, scroller, slide for example, is easily movable relative to the case in a direction which is other than perpendicular to front face. The actuator is coupled with an encoder which provides an output signal to transmitter circuit corresponding to a stimulation level which is applied to the animal, and the transmitter circuit transmits an encoded wireless signal to the receiver.

US 2012/0092170 A1 discloses a gesture-based animal trainer. The gesture-based animal trainer is configured to be used by a person that provides gesture commands to an animal. The term “gesture commands” refers to gestures that are each associated with a respective animal training command, wherein a gesture can be defined as a selected group of movements performed by a person. The gesture-based animal trainer detects whether the person performs a gesture command and provides a stimulus to the animal in accordance with the gesture command. Upon the animal associating the respective stimulus with the gesture command, the gesture-based animal trainer allows the animal to receive the gesture command regardless of whether the person is within the animal's line of sight.

### SUMMARY OF CERTAIN INVENTIVE ASPECTS

The disclosed technology provides hands-free electronic control kit for remote animal training that overcomes the performance limitations according to prior art. Specifically, the disclosed technology provides a device that allows to operate a wireless remote control without holding this remote control in the hand. Finally, the innovation features of this disclosure provide breaking-through technology to the professional dog trainer.

In an embodiment of the disclosed technology, an intelligent hands-free electronic control kit for animal training is provided, comprising:
a hands-free electronic control device in the form of a finger-wearable part, having at least one switch under the form of a push-button and a means of wireless bidirectional telecommunication with a remote control;
a wireless remote control having a means of wireless bidirectional telecommunication on the one hand with the hands-free electronic control device in the form of a finger-wearable part, and on the other with a functional electronic receiver accessory, so that the remote control is able to relay an order triggered by the switch of the hands-free electronic control device towards the electronic receiver accessory; and
a functional electronic receiver accessory, having a means of wireless bidirectional telecommunication with the remote control,
   wherein the switch is provided with means allowing to select and trigger distinct functions of the accessory according to as how the push-button is pressed by an user and optionally according to spatial position/orientation of the hands-free electronic control device.

### BRIEF DESCRIPTION OF THE DRAWINGS

The disclosed technology may be more completely understood in consideration of the following detailed description of embodiments in connection with the accompanying drawings, in which:

FIG. 1 is a diagram which schematically shows a hands-free device for remotely training an animal according to a first embodiment, comprising a ring, a remote control and a training collar.

FIG. 2 is a diagram showing the principle of the above-mentioned ring.

FIG. 3 is a diagram showing the principle of the above-mentioned remote control.

FIG. 4 is a diagram showing the principle of the above-mentioned collar.

FIG. 5 is a diagram which schematically shows an example of switch having different pressure positions.

FIG. 6 is a diagram which schematically shows three examples of how to obtain different types of stimuli depending on how the hands-free kit switch is pressed.

While the disclosed technology is amenable to various modifications and alternative forms, specifics thereof have been shown by way of example in the drawings and will be described in detail. It should be understood, however, that the intention is not to limit aspects of the disclosed technology to the particular embodiments described. On the contrary, the intention is to cover all modifications, equivalents, and alternatives falling within the scope of the disclosed technology.

### DETAILED DESCRIPTION OF CERTAIN INVENTIVE ASPECTS

In order to solve the issues depicted in prior art section above, a first series of embodiments was disclosed in U.S. patent application Ser. No. 12/470,388.

According to these embodiments, the hands-free kit is essentially remotely connected to a button of a specific, well-identified remote control which can actuate accessory devices such as mentioned above. When such a button of the hands-free kit is depressed, it further sends a radio-frequency command, in a low range of a few meters, to the remote control, the remote control translating and further relaying this command to an accessory device at radio-frequency long range (e.g., from about 10 m to a few hundred meters).

According to some embodiments, the hands-free kit comprises a mechanical part enclosing or encompassing a finger of the hand, the index finger in certain embodiments, which will be called in short hereinafter “ring”, but which is not limited to an annular piece of rigid material (see below). The ring comprises, for example, two switches that communicate with the actual remote control. The ring is adapted to be attached to a finger of a hand, for instance the index finger, the thumb then being used to operate the switches. Any type of switch known to those skilled in the art falls within the scope of the disclosed technology (for example, switch under the form of lever, toggle, slide, push-button, dial, touch-sensitive, knob, scroller, etc.).

More specifically, an embodiment of the disclosed technology comprises a hands-free kit for training an animal comprising a ring 1 to be threaded on a finger of the hand, a remote control 2 and a training collar 5 (see FIG. 1). In an embodiment, the presence of two switches 12, 13 is advantageous for animal training since it allows either to reward the behaviour or movement that a dog has just performed (e.g., by a sound signal) or to punish it (e.g., by a punitive electric shock).

Ring 1, as schematically shown in FIG. 1, can be attached to the finger by a suitable attachment device 11 such as a piece of elastic fabric, a Velcro® strap or even by two ergonomic clips in such a way that ring 1 may adapt to fingers of different sizes.

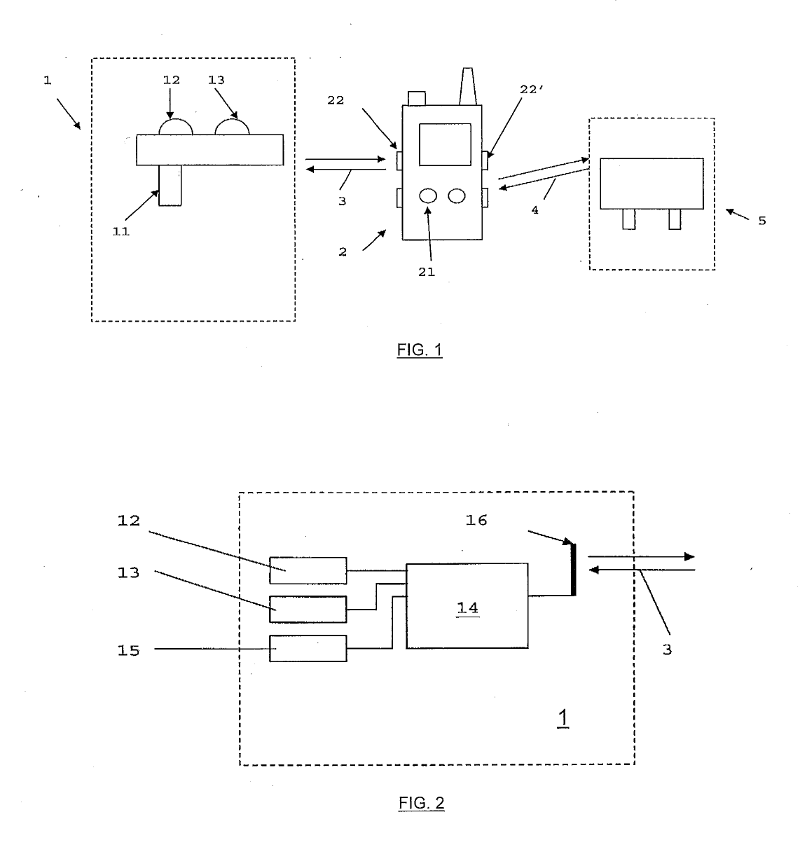

Ring 1 comprises a microcontroller 14 with an RF transmitter/receiver module (not shown) and connected to both above-mentioned switches 12, 13, to a battery 15 and to an aerial 16 on the radio transmitter respectively (see FIG. 2).

An identification code (ID CODE) can be stored in an EEPROM (not shown) linked to the microcontroller 14 and is unique to each ring 1. With each order transmitted, the ID CODE is stated at the start of the sequence, which allows to differentiate between orders sent by different rings that are close to each other.

The remote control 2 which serves to process the information from the ring 1, according to a bidirectional communication 3 at a short distance, e.g., a few meters, and to send/relay the order to the collar 5, according to a bidirectional communication 4 at a long distance, e.g., a few hundred meters or even one or several kilometers.

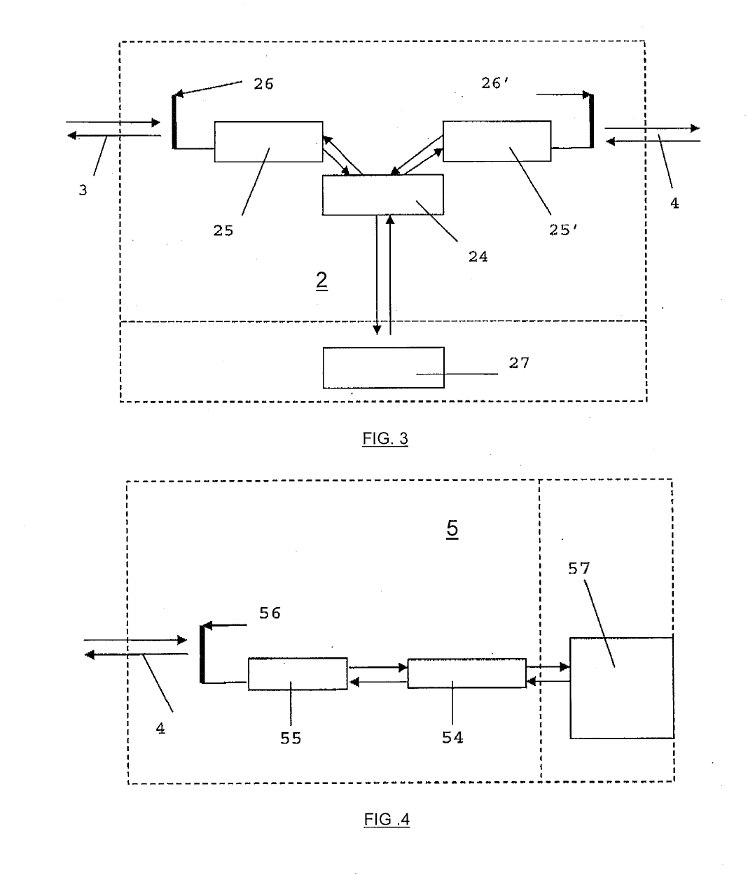

More in detail, the remote control 2 comprises a microcontroller 24 with a bidirectional link on the one hand to a user interface 27 and on the other to a RF transmitter/receiver module 25 associated to an aerial 26 for the bidirectional communication 3 with the ring 1 and a RF transmitter/receiver module 25′ associated to an aerial 26′ for the bidirectional communication 4 with the collar 5 (see FIG. 3).

Moreover, the remote control 2 may operate on its own, without the ring 1. Therefore, to this end, pairs of switches 22, 22′, etc. can be also fitted to the remote control 2 box (see FIG. 1).

Lastly, the collar 5, fitted with traditional training devices or functions, receives information from the remote control 2. It comprises a microcontroller 54 linked on the one hand to an RF transmitter/receiver module 55 connected to an aerial 56 for the bidirectional communication 4 with the remote control 2 and on the other hand to a training system 57 such as for example a high-voltage electric pulse generator or a sound generator (see FIG. 4).

The transmitters/receivers used can be integrated (shared electronics and boxes, transceivers) and can use the ZigBee protocol (protocol IEEE 802.15.4).

If the remote control used can control N collars (N being a positive integer), N rings may possibly be linked to it. Now each ring can control one single collar by utilizing the remote control 2. The synchronisation of the ring m (1≦m≦N) with corresponding collar m can occur during a specific programming sequence.

According to one embodiment, the synchronization of the ring with a collar may then be achieved in the following manner: pressing the “hands-free programming” switch 21 of the remote control for a long time sets it in a specific programming mode. Then one presses one of the two switches 22 on the remote control 2 for dog A, for example. Lastly, one presses one of the two switches 12, 13 on the corresponding ring 1. Then this sends (unique) ID CODE of ring 1 to remote control 2. The remote control 2 finally associates this specific ID CODE with dog A and stores that information in its memory.

If a second ring has to be synchronized, the procedure is started again but using the switches 22′ on the remote control 2 for dog B, for example.

Since each order sequence comprises the ID CODE of the transmitting ring, the remote control can pass the command from the ring on to the intended collar. Moreover, if several users who are close to each other are using the same system, there is no risk of interference.

The two switches 12, 13 on the ring 1 generally correspond to two separate commands for the same collar 5 which can be preprogrammed by the remote control 2.

However, the disclosed technology is not restricted to this particular configuration and other configurations known to those skilled in the art may also be used such as, for example, a configuration where the two switches 12, 13 of the above-mentioned pair control two different and distinct collars A and B, respectively.

However this first kind of solution as presented above hardly allows to do only one thing at a time with the hands-free kit, possibly programmed beforehand by the remote controlled, as the hands-free kit switch is generally associated to one corresponding switch of the remote control and acts as substituted to the latter.

In the above embodiments, the risk is then that the finger ring be used as an unintelligent trivial object, by being able to give one and only one order to the remote control.

In modern training however, the user is required to be able to coordinate different orders and/or accessories, in certain embodiments.

The faster the reaction of the dog handler, the better is the training session as the dog can associate an event or an action to an order only if the time between both instants is small, typically less than one second.

According to a second series of embodiments one introduces a difference as how the hands-free kit switch/button is pressed. In some embodiments, this is performed by:
providing a switch having different positions (e.g., pressure positions),
the way with which the user presses the button (e.g., one press, fast consecutive presses, continuous press),
providing two or more buttons,
orienting the hands-free control device.

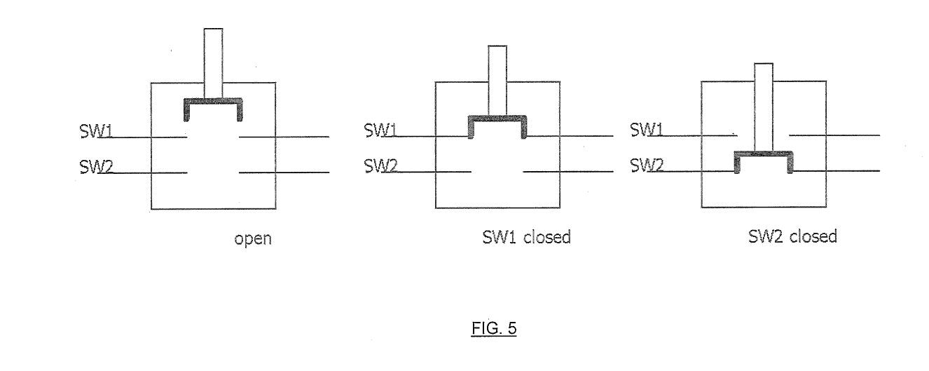

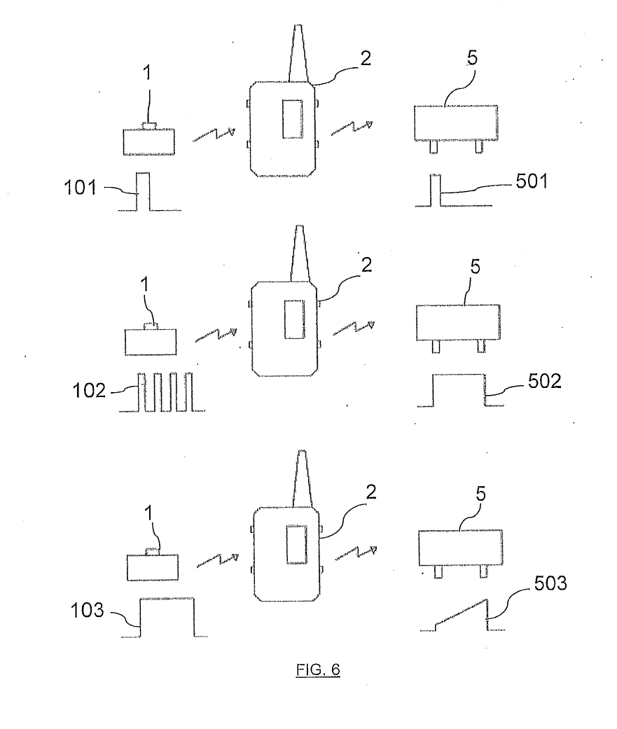

According to one embodiment, different kinds or modes of pressure can be associated to different commands, for example, as shown in FIG. 5:
in a first mode (SW1 closed), to start a bird launcher,
in a second mode (SW2 closed), to start a ball launcher,
   or specifically in the case of controlling an electronic dog collar, as shown in FIG. 6:
single press 101 for a stimulation of less than 100 ms typically (“flash mode” stimulus 501),
fast consecutive presses 102 for a continuous stimulation (“continuous mode” stimulus 502),
continuous press 103 for automatic progressive stimulation (“APS mode” stimulus 503).

According to another embodiment, the choice between the different functions available can be performed depending on the position/orientation of the hands-free kit in space. To this end a low power accelerometer is embedded in the hands-free kit for estimating its position/orientation. For example, if the hands-free kit button is oriented upwards, the dog collar may work in so-called “electronic dog collar mode”; if it is oriented downwards, the dog collar works in so-called “bird launcher mode” or “ball launcher mode”.

According to still another embodiment, the so-called normal intensity level of stimulation is programmed in advance on (and by) the remote control. This level can be used for the two first kinds of stimulation (flash mode 501 and continuous mode 502). For APS mode 503, the programmed level can be use as initial level. This intensity level can be increased by one step (or more) typically every 300 ms.

Moreover, for each technical training approach, a solution could be found using the hands-free kit with a single push-button:
single press 101 for normal care of the dog,
fast consecutive presses 102 (continuous mode) for stimulation strengthening training (for example a first very weak stimulus for providing slight discomfort to the animal followed by two positive stimuli, a first one for releasing the negative stimulus and a second one for congratulating the animal),
APS mode 103 for negative training, the pressure on the button being stopped when the animal stops its unwanted behavior.

According to another embodiment, it is provided a button with a pressure level sensor. The higher the pressure on the button, the higher is the level of stimulation. This embodiment must have a calibration system to adjust the pressure level of each user.

At the light of the teaching of U.S. Pat. No. 8,022,522 B2, another way to add intelligence in the hands-free kit disclosed here is for example to use the electrode quality contact measurement provided by the collar through the bidirectional communication between collar and remote control.

In the aforementioned patent it is proposed to retrieve valuable information from the collar towards the remote control, such as:

battery charge level of the collar;

RF communication quality,

ohmic contact quality of the electrodes.

This information could be readable on a display of the remote control.

Alternately, other physical reactions could be triggered on the remote control such as generating a vibration if the RF link is lost or generating sound if no/poor electrode contact is sensed. However, vibration may not be sensitive enough if the remote control is in a pocket of the trainer or sound could not be heard if there is a lot of noise in the training environment (such as dog barking).

According to one embodiment, the existing bidirectional link between the hands-free control device and the remote control can then be used to uplink information feedback to the hands-free control device. As the latter can be held on the finger, vibration can be very sensitive for the user. For example, one can have

in case of lost RF link: generating pulse vibration;

in case of no/poor electrode-skin contact: generating continuous vibration.

As the bidirectional link can be power consuming, due to demodulation of RF signal, so, according to one embodiment, the RF circuit of the hands-free control device can be set in reception only during a few ms after the button has been depressed and the feedback can be transmitted to the user during or just after this short period of time.

According to another embodiment, the remote Control is designed as a compact watch that could be held at the wrist of the trainer. The watch has only two buttons to change the level of stimulation and a single configuration button, serving to link the hands-free control device to the watch. Additionally the watch comprises:

a long range RF link, to collar or other accessories,

a short range link, to hands-free kit.

The user can communicate with the watch from the hands-free control device and for example choose the stimulation mode as explained above. Information as described above and coming back from the collar can be communicated to the user, for example as a vibration felt on the wrist of the user.

While the disclosed technology has been illustrated and described in detail in the drawings and foregoing description, such illustration and description are to be considered illustrative or exemplary and not restrictive. It will be understood that changes and modifications may be made by those of ordinary skill within the scope of the following claims. In particular, what is disclosed covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SYMBOLS

1. hands-free electronic control device

2. wireless remote control

3. bidirectional telecommunication channel

4. bidirectional telecommunication channel

5. electronic receiver accessory

11. ring

12. switch

13. switch

14. microcontroller

15. battery

16. aerial

21. hands-free programming switch

22. switch

22′. switch

24. microcontroller

25. RF transmitter/receiver module

25′. RF transmitter/receiver module

26. aerial

26′. aerial

27. user interface

54. microcontroller

55. RF transmitter/receiver module

56. aerial

57. training system

101. single short press on switch

102. consecutive short presses on switch

103. continuous press on switch

501. flash stimulus

502. continuous stimulus

503. automatic progressive stimulus

1. An intelligent hands-free electronic control kit for animal training, comprising:
a hands-free electronic control device in the form of a finger-wearable part, having at least one switch including a push-button and a means of wireless bidirectional telecommunication with a remote control;
a wireless remote control having a means of wireless bidirectional telecommunication on the one hand with the hands-free electronic control device in the form of a finger-wearable part, and on the other with a functional electronic receiver accessory, so that the remote control is able to relay an order triggered by the switch of the hands-free electronic control device towards the electronic receiver accessory; and
a functional electronic receiver accessory, having a means of wireless bidirectional telecommunication with the remote control,
wherein the switch is provided with means allowing to select and trigger distinct functions of the accessory according to as how the push-button is pressed by an user and optionally according to spatial position/orientation of the hands-free electronic control device.

2. The intelligent control kit according to claim 1, wherein the push-button is provided with different accessory function triggering positions according to different available pressure levels.

3. The intelligent control kit according to claim 1, wherein the functional accessory is a ball or bird launcher.

4. The intelligent control kit according to claim 1, wherein the functional accessory is an electronic stimulation training collar.

5. The intelligent control kit according to claim 4, wherein a first stimulation mode, called “flash mode”, is associated with a single short press of the push-button, a second stimulation mode, called “continuous mode”, is associated with a sequence of consecutive fast and short presses of the push-button and a third stimulation mode, called “automatic progressive stimulation”, is associated with a continuous press of the push-button.

6. The intelligent control kit according to claim 5, wherein a predetermined level of stimulation is programmed by the wireless remote control, corresponding to a peak level of stimulation in the first and second stimulation modes, and to an initial stimulation level in the third stimulation mode, the latter being intended to be followed by one or more step increases.

7. The intelligent control kit according to claim 1, wherein the switch is provided with a pressure sensor, allowing to increase the stimulation level as the pressure on the push-button increases and with a calibration system in order to adjust a desired pressure level to each user.

8. The intelligent control kit according to claim 1, wherein a low power accelerometer or inclinometer is embedded in the hands-free electronic control device.

9. The intelligent control kit according to claim 1, wherein a selection between two distinct accessory functions is obtained by spatially orienting the hands-free electronic control device upwards and downwards respectively.

10. The intelligent control kit according to claim 4, wherein the hands-free electronic control device is provided with a vibration means, so that, when specific information is retrieved by the remote control from the electronic stimulation training collar and relayed as uplink feedback information to the hands-free electronic control device, vibration is triggered so that the user gets aware of this information.

11. The intelligent control kit according to claim 10, wherein the triggered vibration is a pulse vibration or a continuous vibration according to a type and/or value of the relayed feedback specific information.

12. The intelligent control kit according to claim 10, wherein the specific information is selected from the group consisting of a collar battery charge level, a radio-frequency communication quality estimation and an ohmic contact quality estimation of electrodes embedded in the collar.

13. The intelligent control kit according to claim 4, wherein the wireless remote control is embedded in a watch to be worn on the wrist or in the hand of the user, the watch having two buttons for changing the stimulation level and one configuration button for linking the hands-free electronic control device to the watch.

14. The intelligent control kit according to claim 13, wherein the watch is provided with a vibration means, so that, when specific feedback information is retrieved by the remote control from the electronic stimulation training collar, vibration is triggered and felt by the user in a wrist or hand.

15. An intelligent hands-free electronic control system for animal training, the system comprising:
a hands-free, finger-wearable electronic control device having at least one push-button switch and a wireless bidirectional telecommunication circuit for wireless communication;
an electronic receiver accessory having a wireless bidirectional telecommunication circuit for wireless communication, the electronic receiver accessory configured to perform a plurality of distinct functions; and
a wireless remote control having a wireless bidirectional telecommunication circuit configured for wireless communication with the electronic control device, and for further communication with the electronic receiver accessory,
wherein the wireless remote control is configured to relay an order triggered by the push-button switch of the electronic control device towards the electronic receiver accessory, and wherein the push-button switch is configured to select and trigger a distinct function of the plurality of distinct functions of the electronic receiver accessory according to how the push-button is pressed by a user.

16. The intelligent control system according to claim 15, wherein the push-button is configured with different accessory function triggering positions associated with different available pressure levels.

17. The intelligent control system according to claim 15, wherein the electronic receiver accessory is an electronic stimulation training collar.

18. The intelligent control system according to claim 17, wherein a first flash stimulation mode is associated with a single short press of the push-button, a second stimulation mode is associated with a sequence of consecutive fast and short presses of the push-button and a third progressive stimulation mode is associated with a continuous press of the push-button, and wherein a predetermined level of stimulation is programmed by the wireless remote control, corresponding to a peak level of stimulation in the first and second stimulation modes, and to an initial stimulation level in the third progressive stimulation mode, the latter being intended to be followed by one or more automatic step increases.

19. The intelligent control system according to claim 15, wherein the push-button switch includes a pressure sensor, configured to increase the stimulation level as the pressure on the push-button increases, and with a calibration system in order to adjust a desired pressure level to each user.

20. The intelligent control system according to claim 17, wherein the electronic control device includes a vibration circuit such that when specific information is retrieved by the remote control from the electronic stimulation training collar and relayed as uplink feedback information to the electronic control device, a vibration is triggered so that the user is alerted of the specific information, wherein the triggered vibration is one of a pulse vibration and a continuous vibration according to a type and/or value of the relayed feedback specific information, and wherein the specific information is one of the following: a collar battery charge level, a radio-frequency communication quality estimation and an ohmic contact quality estimation of electrodes embedded in the collar.

21. The intelligent control system according to claim 17, wherein the wireless remote control is embedded in a watch configured to be worn on the wrist or in the hand of the user, the watch having two buttons for changing the stimulation level and one configuration button for linking the electronic control device to the watch, wherein the watch is configured with a vibration circuit, such that when specific feedback information is retrieved by the remote control from the electronic stimulation training collar, a vibration is triggered and felt by the user on a wrist or hand.

22. The intelligent control system according to claim 15, wherein the wireless remote control is configured to relay the order triggered by the push-button switch of the electronic control device so as to control the functions of the electronic receiver accessory.

23. A method of animal training utilizing an intelligent hands-free electronic control device and a wireless remote control, the method comprising:
receiving a selected order for a distinct function at a hands-free electronic control device;
wirelessly receiving at a remote control the order triggered by a switch of the electronic control device for control of an electronic receiver accessory;
wirelessly relaying the order to the electronic receiver accessory;
triggering one of a plurality of distinct functions of the electronic receiver accessory according to how the switch is pressed by a user and according to a spatial position/orientation of the hands-free electronic control device, wherein the switch is configured with different electronic receiver accessory function triggering positions associated with different available pressure levels.

24. The method according to claim 23, wherein the electronic receiver accessory is an electronic stimulation training collar.

25. The method according to claim 24, wherein a first flash stimulation mode is associated with a single short press of the switch, a second stimulation mode is associated with a sequence of consecutive fast and short presses of the switch and a third progressive stimulation mode is associated with a continuous press of the switch, and additionally comprising programming a predetermined level of stimulation by the wireless remote control corresponding to a peak level of stimulation in the first and second stimulation modes and to an initial stimulation level in the third progressive stimulation mode, the latter being intended to be followed by one or more automatic step increases.

26. The method according to claim 24, additionally comprising:
retrieving specific information from the electronic stimulation training collar by the wireless remote control;
relaying the specific information as uplink feedback information to the electronic control device; and
triggering a vibration in the electronic control device so that the user is alerted of the specific information.

27. The method according to claim 24, wherein the wireless remote control is embedded in a watch configured to be worn on the wrist or in the hand of the user, the watch having two buttons for changing the stimulation level and one configuration button for linking the electronic control device to the watch, and wherein when specific feedback information is retrieved by the remote control from the electronic stimulation training collar, triggering a vibration felt by the user on a wrist or hand.
